(19) United States
(12) Patent Application Publication
(10) Pub. No.: US 2025/0193585 A1
(43) Pub. Date: Jun. 12, 2025

(54) ACOUSTIC SYSTEM, ACOUSTIC SYSTEM CONTROL METHOD, AND ACOUSTIC SYSTEM MANUFACTURING METHOD

(71) Applicants: Panasonic Automotive Systems Co., Ltd., Kanagawa (JP); Panasonic Connect Co., Ltd., Fukuoka (JP)

(72) Inventors: Tatsuya SHIMIZU, Hyogo (JP); Keisuke FUJIMOTO, Osaka (JP); Koji SANO, Kanagawa (JP); Yasunori MIYAMOTO, Kanagawa (JP)

(73) Assignees: Panasonic Automotive Systems Co., Ltd., Kanagawa (JP); Panasonic Connect Co., Ltd., Fukuoka (JP)

(21) Appl. No.: 18/972,127

(22) Filed: Dec. 6, 2024

(30) Foreign Application Priority Data
Dec. 11, 2023 (JP) 2023-208605
Nov. 6, 2024 (JP) 2024-194275

(51) Int. Cl. H04R 1/34; H04R 3/04

(52) U.S. Cl. CPC H04R 1/345; H04R 3/04

(57) ABSTRACT

An acoustic system includes: a sound generation device that generates a sound wave based on an acoustic signal; a vibrator that applies vibration to a vibration member to which the vibrator is attached; and a correction filter that (i) corrects the acoustic signal to reduce transmitted sound that has changed from the sound wave by transmitting through the vibration member, and (ii) outputs the acoustic signal corrected to the vibrator. The correction filter has a filter property derived based on the transfer characteristic of the transmitted sound.

### CROSS REFERENCE TO RELATED APPLICATION

The present application is based on and claims priority of Japanese Patent Application No. 2023-208605 filed on Dec. 11, 2023 and Japanese Patent Application No. 2024-194275 filed on Nov. 6, 2024. The entire disclosures of the above-identified applications, including the specification, drawings and claims are incorporated herein by reference in their entirety.

### FIELD

The present disclosure relates to an acoustic system that proactively blocks sound waves, an acoustic system control method, and an acoustic system manufacturing method.

### BACKGROUND

Patent Literature (PTL) 1 discloses techniques of reducing noises that transmit through from a noise source to an external space by inputting, to a vibrator attached to a wall that separates the external space from a room in which the noise source is placed, a control signal generated based on the output signal of the noise source and the output signal of an interference sound microphone placed in the external space so that interference sound, which is the difference between controlled sound and transmitted sound emitted from a wall surface to the external space, becomes the smallest.

### CITATION LIST

### Patent Literature

PTL 1: Japanese Unexamined Patent Application Publication No. H08-314471

### SUMMARY

### Technical Problem

However, the techniques disclosed in PTL 1 mentioned above can be improved upon.

In view of this, the present disclosure provides an acoustic system, an acoustic system control method, and an acoustic manufacturing method capable of improving upon the above related art.

### Solution to Problem

An acoustic system according to one aspect of the present disclosure includes: a sound generation device that generates a sound wave based on an acoustic signal; a vibrator that applies vibration to a vibration member to which the vibrator is attached; and a correction filter that (i) corrects the acoustic signal to reduce transmitted sound that has changed from the sound wave by transmitting through the vibration member, and (ii) outputs the acoustic signal corrected to the vibrator. The correction filter has a filter property derived based on the transfer characteristic of the transmitted sound.

An acoustic system control method according to one aspect of the present disclosure is an acoustic system control method of setting a filter property of a correction filter included in an acoustic system including: a sound generation device that generates a sound wave based on an acoustic signal; a vibrator that applies vibration to a vibration member to which the vibrator is attached; and a correction filter that (i) corrects the acoustic signal to reduce transmitted sound that has changed from the sound wave by transmitting through the vibration member, and (ii) outputs the acoustic signal corrected to the vibrator. The acoustic system control method includes: placing the sound generation device on one side of the vibration member to which the vibrator is attached; placing a measurement device on the other side of the vibration member; obtaining a target measurement signal by causing the measurement device to measure a sound wave generated by the sound generation device based on the acoustic signal; and setting the filter property of the correction filter based on a target sound-pressure transfer function between the acoustic signal and the target measurement signal.

An acoustic system manufacturing method according to one aspect of the present disclosure is an acoustic system manufacturing method for manufacturing an acoustic system including: a sound generation device that generates a sound wave based on an acoustic signal; a vibrator that applies vibration to a vibration member to which the vibrator is attached; and a correction filter that (i) corrects the acoustic signal to reduce transmitted sound that has changed from the sound wave by transmitting through the vibration member, and (ii) outputs the acoustic signal corrected to the vibrator. The acoustic system manufacturing method includes: placing the sound generation device on one side of the vibration member to which the vibrator is attached; placing a measurement device on the other side of the vibration member; obtaining a target measurement signal by causing the measurement device to measure at least one of (i) a sound wave generated by the sound generation device based on the acoustic signal or (ii) vibration of the vibration member caused by the sound wave generated by the sound generation device; and setting the filter property of the correction filter based on a target sound-pressure transfer function between the acoustic signal and the target measurement signal.

### Advantageous Effects

An acoustic system, an acoustic system control method, and an acoustic system manufacturing method according to one aspect of the present disclosure are capable of improving upon the above related art.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating Example 1 of application of an acoustic system.

FIG. 2 is a diagram illustrating Example 2 of application of the acoustic system.

FIG. 3 is a diagram illustrating a state in which a sound generation device for measurement is derived in a property generation system.

FIG. 4 is a diagram illustrating a state in which a vibrator for measurement is derived in the property generation system.

FIG. 5 is a diagram illustrating another example of the property generation system.

FIG. 6 is a diagram illustrating a state in which a sound generation device for measurement according to another Example 1 is derived in the property generation system.

### DESCRIPTION OF EMBODIMENT

Hereinafter, embodiments of an acoustic system, an acoustic system control method, and an acoustic system manufacturing method according to the present disclosure will be described with reference to the drawings. Note that the embodiments described below each show an example of the present disclosure, and are not intended to limit the scope of the present disclosure. For example, the shapes, structures, materials, elements, relative positional relationships, connection states, numeral values, mathematical formulae, a process in each step in a method, an order of steps, etc., indicated in the following embodiments are mere examples, and may therefore include those not described in the following. Moreover, geometric expressions such as “parallel” and “orthogonal” may be used, but these expressions each do not indicate a mathematical strictness and include a difference or deviation that is substantially allowed. Expressions such as “simultaneously” and “same” each also include a range that is substantially allowed.

Moreover, the drawings are schematic illustrations in which emphasis, omission, or ratio adjustment is made where necessary to illustrate the present disclosure. Accordingly, the shapes, positional relationships, and ratios of elements may be different from the actual shapes, positional relationships, and ratios of the elements.

In the following, a plurality of inventions may be generally described as one embodiment. A part of the following description provides an illustration of elements that are optional for the present disclosure.

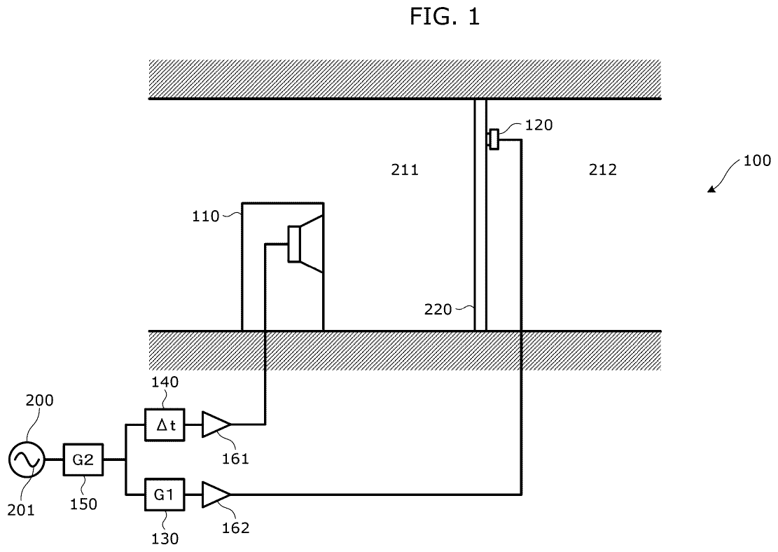

FIG. 1 is a diagram illustrating acoustic system 100. Acoustic system 100 is a system that generates sound waves in first space 211 that is predetermined and reduces the sound volume of transmitted sound that has transmitted through vibration member 220 in second space 212 separated from first space 211 by vibration member 220. In other words, acoustic system 100 is a system that reduces the vibration of vibration member 220 caused by sound waves generated in first space 211. Acoustic system 100 includes sound generation device 110, vibrator 120, and correction filter 130. In the present embodiment, acoustic system 100 includes delay filter 140, common filter 150, first drive amplifier 161, and second drive amplifier 162.

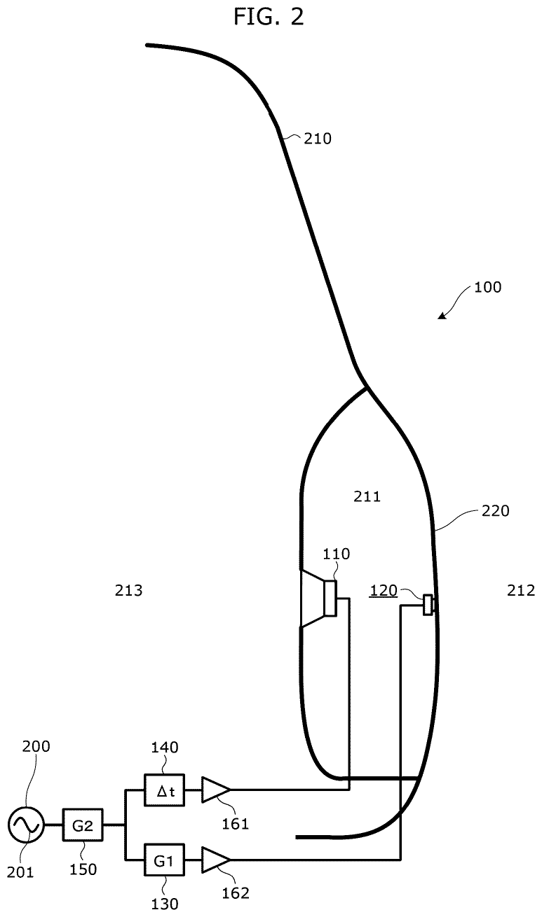

First space 211 is a space in which sound waves are emitted by sound generation device 110. First space 211 is not limited to this example. As illustrated in FIG. 2, first space 211 may be, for example, a space that is an internal space in a mobile object such as a vehicle, a vessel, or an aircraft, and that functions as a cabinet (enclosure) that blocks back sounds that travel behind the loudspeaker unit of sound generation device 110 when sound generation device 110 emits sound waves to mobile object internal space 213 of the mobile object. Furthermore, first space 211 may be an internal space in a cabinet (enclosure) of a typical loudspeaker system.

Second space 212 is a space separated from first space 211 by vibration member 220. Second space 212 is a space in which sound waves, which have been emitted in first space 211 by sound generation device 110, are desired to be transmitted through the vibration member and thus propagated as less as possible. Note that first space 211 and second space 212 may be separated from each other by vibration member 220 or may be spatially continuous although separated by vibration member 220. Alternatively, when first space 211 is an internal space in a cabinet (enclosure) of a loudspeaker system, for instance, second space 212 may be spatially continuous with mobile object internal space 213 in which sound generation device 110 emits sound waves, or may be a space equivalent to mobile object internal space 213. Mobile object internal space 213 is not limited to this example. When first space 211 is an internal space in a cabinet (enclosure) of a typical loudspeaker system, for example, mobile object internal space 213 may be a non-moving indoor space or a non-moving outdoor space in which sound waves are emitted from sound generation device 110.

Vibration member 220 is a member to which vibration is applied by vibrator 120. Vibration member 220 is not limited to this example. For example, vibration member 220 may be a part or the whole of a door or a part or the whole of the body of a mobile object such as a vehicle, a vessel, or an aircraft, as illustrated in FIG. 2. Vibration member 220 may be, for instance, a wall or a fence provided to separate first space 211 from second space 212. When first space 211 is an internal space in a cabinet (enclosure) of a loudspeaker system, for instance, vibration member 220 may be a structural member of the cabinet (enclosure).

Sound generation device 110 is a device that generates a sound wave in first space 211 based on acoustic signal 201 output from signal source 200. The type of sound generation device 110 is not limited to this example. For example, sound generation device 110 may be, for instance, a loudspeaker unit, a vibrator for sound generation which causes an object to vibrate to emit sound. Sound generation device 110 may include, for instance, a cabinet (enclosure) that accommodates a loudspeaker unit and a vibration member to which a vibrator for sound generation is to be attached. Sound generation device 110 may also include a plurality of loudspeaker units and a plurality of vibrators for sound generation, and may be a multi-way loudspeaker including various types of loudspeaker units.

Vibrator 120 is attached to vibration member 220, is a so-called actuator (exciter) that causes vibration member 220 to vibrate based on acoustic signal 201 that has been input, and includes: a vibration unit that generates excitation force; and a reaction force generation mechanism for generating reaction force against excitation force. Acoustic signal 201 output to vibrator 120 and acoustic signal 201 output to sound generation device 110 are acoustic signals 201 output from the same source, and acoustic signal 201 output from the same signal source 200 is diverged and respectively output to sound generation device 110 and vibrator 120. The type of the vibration unit of vibrator 120 is not limited to this example, and may be, for instance, a vibration unit for which a magnet is used, a vibration unit for which a piezoelectric element is used, or a vibration unit for which a magnetostrictive element is used. Moreover, the reaction force generation mechanism of vibrator 120 may be a reaction force generation mechanism that uses inertia force generated by the mass effect of a movable part including a magnet or the like, or a reaction force generation mechanism that uses structural reaction force generated by connecting one end of the movable part to other structural member. The number of vibration units included in vibrator 120 is not limited to one, and vibrator 120 may include plural, preferably three or more vibration units arranged in the same plane that is not on the same straight line, or arranged in a three-dimensional position, and movable parts of the vibration units may be connected to each other. In a vibrator in which the movable parts of the vibration units are connected to each other, since oscillation of a movable part, which is likely to be generated in the configuration of a single vibration unit, is reduced owing to the effect of moment reaction force generated by a distance between vibration units, it is easy to set the filter property of correction filter 130 to be described later, and an advantage is that the sound insulation performance of acoustic system 100 is enhanced. In this case, the drive current of vibrator 120 may be (i) acoustic signal 201 to be supplied in parallel to vibration units via a single correction filter 130 and a single second drive amplifier 162, or (ii) acoustic signal 201 to be solely supplied to vibration units via correction filters 130 and second drive amplifiers 162.

Correction filter 130 is a filter that corrects acoustic signal 201 to be output to vibrator 120 to reduce transmitted sound that has changed from sound waves that were emitted in first space 211 by sound generation device 110 and pass through vibration member 220 to reach second space 212. In the present embodiment, correction filter 130 has a filter property unique to acoustic system 100. The filter property of correction filter 130 is a property determined by at least sound generation device 110, vibrator 120, and vibration member 220 to which vibrator 120 is attached. A method of setting the filter property of correction filter 130 will be described in detail later.

Delay filter 140 is a filter that delays acoustic signal 201 to be output to sound generation device 110 by only Δt (a fixed value) compared to acoustic signal 201 to be output to vibrator 120. Note that “t” represents time.

Common filter 150 is a filter that corrects acoustic signal 201 to be output to each of vibrator 120 and sound generation device 110. Common filter 150 is a filter that cuts a signal component that is an amount of sound waves generated by sound generation device 110 which correction filter 130 alone or correction filter 130 and delay filter 140 alone cannot prevent from transmitting through vibration member 220. In the present embodiment, common filter 150 corrects acoustic signal 201 that is output from sound source 200 and has not been diverged. Note that common filter 150 may correct each of acoustic signals 201 that have been diverged. In other words, common filter 150 corrects at least one of acoustic signal 201 that has not been diverged or acoustic signal 201 that has been diverged.

First drive amplifier 161 amplifies acoustic signal 201, which has been output from signal source 200, until sound generation device 110 is driven so that sound can be emitted in first space 211. In the present embodiment, first drive amplifier 161 amplifies acoustic signal 201 that has been corrected by common filter 150 and then by delay filter 140.

Second derive amplifier 162 amplifies acoustic signal 201, which has been output from signal source 200, to reduce the amount of sound waves that were emitted in first space 211 as a result of driving vibrator 120 causing vibration member 220 to vibrate, and that pass through second space 212. In the present embodiment, second drive amplifier 162 amplifies acoustic signal 201 corrected by common filter 150 and then by correction filter 130.

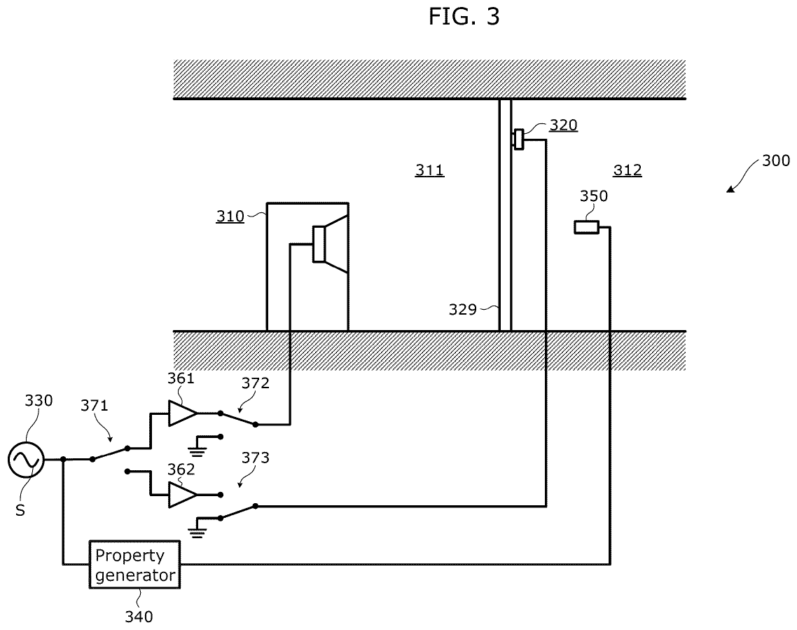

Next, property generation system 300 capable of setting the filter property of correction filter 130 included in acoustic system 100 will be described. FIG. 3 is a diagram illustrating property generation system 300. Property generation system 300 generates a filter property of correction filter 130 included in acoustic system 100, and includes sound generation device for measurement 310, vibrator for measurement 320, vibration member for measurement 329, sound source for measurement 330, property generator 340, measurement device 350, first measurement amplifier 361, second measurement amplifier 362, first changeover switch 371, second changeover switch 372, and third changeover switch 373.

Sound generation device for measurement 310 is a device that generates sound waves in first measurement space 311 based on measurement acoustic signal S to be output from sound source for measurement 330. It is desirable that sound generation device for measurement 310 is a device that is the same or of the same type as sound generation device 110. It is also desirable that how sound generation device for measurement 310 is attached to a cabinet or the like is same or substantially same as how sound generation device 110 is attached. The position and orientation of sound generation device for measurement 310 relative to vibration member for measurement 329 are also same or substantially same as the position and orientation of sound generation device 110 relative to vibration member 220 of sound generation device 110.

Vibrator for measurement 320 is a device that causes vibration member for measurement 329 to vibrate based on measurement acoustic signal S to be output from sound source for measurement 330. It is desirable that vibrator for measurement 320 is the same or of the same type as vibrator 120. It is also desirable that how vibrator for measurement 320 is attached to vibration member for measurement 329 is same or substantially same as how vibrator 120 is attached to vibration member 220.

Sound source for measurement 330 outputs measurement acoustic signal S. Measurement acoustic signal S is not necessarily an acoustic signal to be output to acoustic system 100. Measurement acoustic signal S may be, for example, an acoustic signal, a sign curve signal, a sweep sign signal, an impulse signal, a random-noise signal, a colored noise signal, an M series signal, or a time stretched pulse (TSP) signal that is predetermined.

Measurement device 350 is a device that measures sound waves generated in second measurement space 312 by driving sound generation device for measurement 310 or vibrator for measurement 320, or vibration generated in vibration member for measurement 329 by driving sound generation device for measurement 310 or vibrator for measurement 320. Measurement device 350 that measures sound waves may be a microphone. Measurement device 350 that measures vibration may be a displacement sensor, a speed sensor, or an acceleration sensor. Property generation system 300 may include a plurality of measurement devices 350.

Property generator 340 derives the filter property of correction filter 130 included in acoustic system 100 based on a target sound-pressure transfer function between measurement acoustic signal S and target measurement signal Ps obtained by measuring, in second measurement space 312, which is not first measurement space 311 in which sound generation device for measurement 310 is placed, in vibration member for measurement 329, (i) sound waves generated by sound generation device for measurement 310 based on measurement acoustic signal S, or (ii) vibration of vibration member for measurement 329 caused by the sound waves. In the present embodiment, property generator 340 derives the filter property of correction filter 130 also based on a corresponding sound-pressure transfer function between measurement acoustic signal S and corresponding measurement signal Pv obtained by measuring, at the same position at which target measurement signal Ps has been measured, (i) sound waves generated as a result of vibrator for measurement 320 causing vibration member for measurement 329 to vibrate based on measurement acoustic signal S, or (ii) the vibration of vibration member for measurement 329. Property generator 340 derives the filter property using Fourier transform. A deriving method will be described in detail later. Property generator 340 is a processing unit implemented by causing a processor included in a dedicated or general-purpose computer to execute a property generation program.

First measurement amplifier 361 amplifies measurement acoustic signal S, which has been output from sound source for measurement 330, until sound generation device for measurement 310 is driven so that sound is emitted in first measurement space 311. It is desirable that first measurement amplifier 361 is the same or of the same type as first drive amplifier 161.

Second measurement amplifier 362 amplifies measurement acoustic signal S, which has been output from sound source for measurement 330, until vibrator for measurement 320 is driven to cause vibration member for measurement 329 to vibrate. It is desirable that second measurement amplifier 362 is the same or of the same type as second drive amplifier 162.

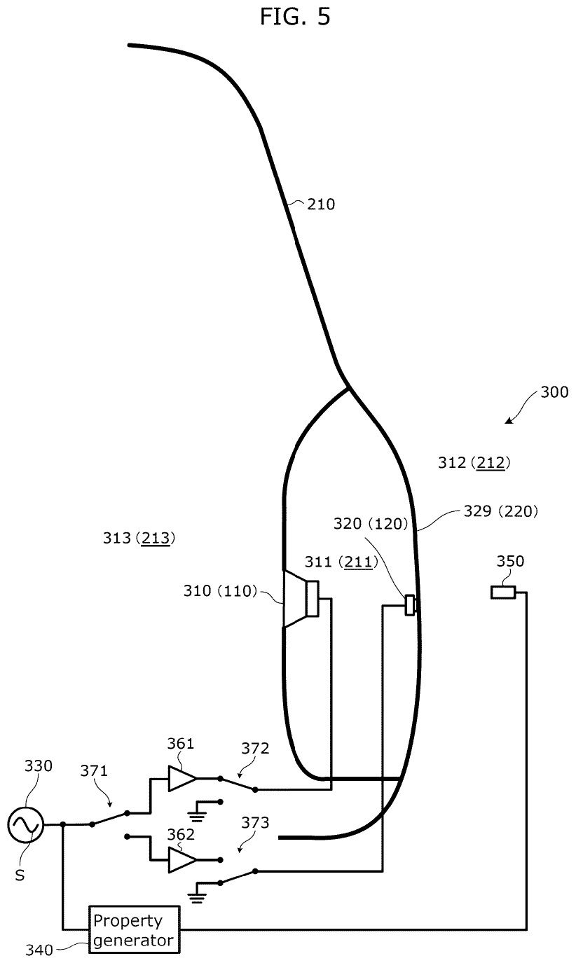

Property generation system 300 may generate a filter property using part of acoustic system 100 attached to mobile object 210 or the like, as illustrated in FIG. 5.

Next, a method of manufacturing acoustic system 100 that uses property generation system 300 will be described. As illustrated in FIG. 3, sound generation device for measurement 310 is placed in a predetermined location in first measurement space 311. Vibrator for measurement 320 is attached to a predetermined location of vibration member for measurement 329. Vibration member for measurement 329 is placed in first measurement space 311 that is one side of vibration member for measurement 329 to which vibrator for measurement 320 is attached. Measurement device 350 is placed in a predetermined location in second measurement space 312 that is the other side of vibration member for measurement 329. When measuring sound waves in second measurement space 312, measurement device 350 is placed in a location distant from vibration member for measurement 329. When measuring vibration of vibration member for measurement 329, measurement device 350 is placed to contact vibration member for measurement 329.

First changeover switch 371 and second changeover switch 372 are switched to cause sound generation device for measurement 310 to generate sound waves based on measurement acoustic signal S (see FIG. 3). In this case, third changeover switch 373 is switched so that vibrator for measurement 320 is short-circuited.

Sound waves generated by sound generation device for measurement 310 or vibration of vibration member for measurement 329 caused by the sound waves are measured by measurement device 350 to obtain target measurement signal Ps. At this stage, property generator 340 may derive filter property G of correction filter 130 based on target sound-pressure transfer function Hs between measurement acoustic signal S and target measurement signal Ps.

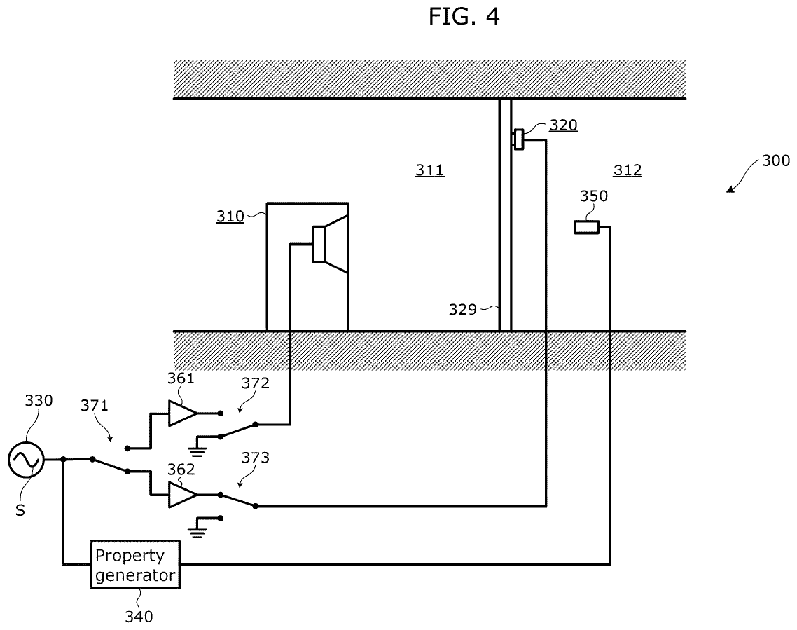

Next, in the present embodiment, first changeover switch 371 and third changeover switch 373 are switched to cause vibrator for measurement 320 to vibrate vibration member for measurement 329 based on acoustic signal S (see FIG. 4). In this case, second changeover switch 372 may be switched so that sound generation device for measurement 310 is short-circuited.

Sound waves generated as a result of vibrator for measurement 320 causing vibration member for measurement 329 to vibrate based on measurement acoustic signal S or vibration of vibration member for measurement 329 are measured by measurement device 350 without changing the location of measurement device 350 that has measured target measurement signal Ps, to measure target measurement signal Pv. Property generator 340 derives corresponding sound-pressure transfer function Hv between measurement acoustic signal S and corresponding measurement signal Pv, and derives filter property G of correction filter 130 based on target sound-pressure transfer function Hs that has been derived first, using the following equations.

$$Hs = Ps / S$$

$$Hv = Pv / S$$

$$Inverse function calculation : Hs \times S + Hv \times G \times S = 0$$

Based on the above, the mathematical expression G=−Hs/Hv holds true.

Acoustic system 100 can be manufactured by setting filter property G of correction filter 130 generated by property generator 340 for correction filter 130 included in acoustic system 100.

When target measurement signal Ps is measured, the following effects can be obtained by short circuiting vibrator for measurement 320. In other words, vibration member for measurement 329 vibrates due to sound waves generated by sound generation device for measurement 310, and induced current is generated in the internal wiring of vibrator for measurement 320 due to the vibration. Electric energy of the generated induced current is consumed by the internal resistance of vibrator for measurement 320. For the consumption of the electric energy, vibrator for measurement 320 apparently behaves as if the attenuation of the mechanical vibration system increased. This state is the same as a state in which vibrator 120 is reducing vibration of vibration member 220 caused by sound waves generated by sound generation device 310 in acoustic system 100, and it is possible to enhance the accuracy of filter property G derived by property generation system 300 and efficiently reduce the amount of sound waves that were generated by sound generation device 310 and pass through vibration member 220.

The present disclosure is not limited to the above embodiment. For example, another embodiment achieved by arbitrarily combining elements described in the present specification or excluding some of the elements may be regarded as an embodiment of the present disclosure. Variations obtained through various modifications to the above embodiment which may be conceived by those skilled in the art are also included in the present disclosure so long as they do not depart from the essence of the present disclosure, i.e., the meaning of wording in the claims.

The embodiment illustrates an example of manufacturing acoustic system 100 in which a filter property, which is derived from a measurement result based on property generation system 300, is set for correction filter 130, but the filter property of correction filter 130 may be derived by numerical analysis simulation such as a finite element method (FEM) or an equivalent circuit analysis method (LEM) using lumped constant elements, and the derived filter property may be set for correction filter 130 in acoustic system 100.

The embodiment illustrates an example in which measurement device 350 placed in one location measures target measurement signal Ps and corresponding measurement signal Pv so that filter property G of correction filter 130 is derived, but a plurality of measurement devices 350 may be placed in multiple locations or the location of measurement device 350 may be changed so that a plurality of target measurement signals Ps and a plurality of corresponding measurement signals Pv are measured, and filter property G may be derived based on the measurement results. In this case, filter property G may be derived using a single target measurement signal Ps and a single corresponding measurement signal Pv calculated by performing statistical processing such as a least square method on the plurality of target measurement signals Ps or the plurality of corresponding measurement signals Pv.

The embodiment illustrates an example in which the acoustic system operates based on acoustic signals reproduced in real-time, but (i) a signal obtained by causing an original acoustic signal to pass through the correction filter or by convoluting the original acoustic signal and (ii) a signal obtained by adding, to the original acoustic signal, a fixed delay corresponding to the correction filter may be prepared in a storage device in advance, both of the signals may be reproduced in synchronization, and the former signal may be supplied to the vibrator while the latter signal is supplied to the sound generation device.

The embodiment illustrates an example of property generation system 300 in which second changeover switch 372 and third changeover switch 373 are arranged on the output terminal side of first measurement amplifier 361 and second measurement amplifier 362, but second changeover switch 372 and third changeover switch 373 may be arranged on the input terminal side of first measurement amplifier 361 and second measurement amplifier 362. In this case, by using, as a measurement amplifier, a voltage-driven amplifier whose output impedance is sufficiently low, the same effects as produced when the changeover switches arranged on the output terminal side are short-circuited can be obtained through the short circuit of the input terminals of the measurement amplifiers to a ground potential.

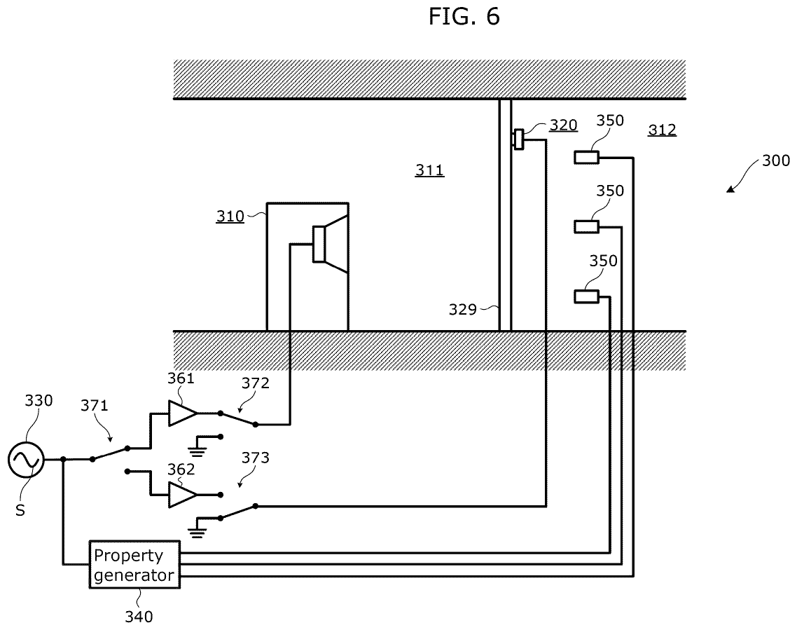

In the acoustic system manufacturing method, filter property G of correction filter 130 may be set based on a process sound-pressure transfer function obtained by performing statistical processing on a plurality of corresponding sound-pressure transfer functions that are based on an acoustic signal and a plurality of target measurement signals obtained at multiple locations whose number (the number may be singular) is different from the number of vibrators for measurement 320 attached to vibration member for measurement 329, as illustrated in FIG. 6.

Target measurement signals may be simultaneously obtained using a plurality of measurement devices 350, as illustrated in FIG. 6, or a single measurement device 350 or a plurality of measurement devices 350 may be displaced to obtain target measurement signals whose number is larger than the number of measurement devices 350.

Acoustic system 100 according to a first aspect of the present disclosure includes: sound generation device 110 that generates a sound wave based on acoustic signal 201; vibrator 120 that applies vibration to vibration member 220 to which vibrator 120 is attached; and correction filter 130 that (i) corrects acoustic signal 201 to reduce transmitted sound that has changed from the sound wave by transmitting through vibration member 220 and propagating far away in the air, and (ii) outputs acoustic signal 201 corrected to vibrator 120. Correction filter 130 has a filter property derived based on the transfer characteristics of the transmitted sound which are obtained in advance.

According to the first aspect of the present disclosure, it is possible to reduce the amount of sound waves that were generated by sound generation device 110 and pass through vibration member 220.

Acoustic system 100 according to a second aspect of the present disclosure is the acoustic system according to the first aspect, and includes delay filter 140 that delays and outputs acoustic signal 201 to sound generation device 110.

According to the second aspect of the present disclosure, it is possible to correct a delay caused by, for instance, the difference between a path through which acoustic signal 201 to be output to sound generation device 110 passes and a path through which acoustic signal 201 to be output to vibrator 120 passes, thereby effectively reducing the amount of sound that passes through vibration member 220.

Acoustic system 100 according to a third aspect of the present disclosure is the acoustic system according to the first aspect or second aspect, and includes common filter 150 that corrects both (i) acoustic signal 201 to be output to vibrator 120 and (ii) acoustic signal 201 to be output to sound generation device 110.

According to the third aspect of the present disclosure, it is possible to cut a signal component that is an amount of sound that cannot be reduced due to the vibration of vibration member 220 caused by vibrator 120, thereby reducing the amount of sound that passes through vibration member 220.

Acoustic system 100 according to a fourth aspect of the present disclosure is the acoustic system according to any one of the first to third aspects, and correction filter 130 has a filter property derived based on a target sound-pressure transfer function between a target measurement signal and acoustic signal 201, where the target measurement signal is obtained by measuring, on a side of vibration member 220 at which sound generation device 110 is not placed, at least one of (i) a sound wave generated by sound generation device 110 based on acoustic signal 201 or (ii) vibration excited by vibration member 220 due to the sound wave generated by sound generation device 110.

According to the fourth aspect of the present disclosure, it is possible to introduce correction filter 130 adapted to actual conditions to acoustic system 100, thereby effectively reducing the amount of sound that passes through vibration member 220.

Acoustic system 100 according to a fifth aspect of the present disclosure is the acoustic system according to the fourth aspect, and the correction filter has a filter property derived based on a corresponding sound-pressure transfer function between a corresponding measurement signal and acoustic signal 201, where the corresponding measurement signal is obtained by measuring, at a position at which the target measurement signal has been measured, at least one of (i) a sound wave generated as a result of vibrator 120 causing vibration member 220 to vibrate based on acoustic signal 201 or (ii) the vibration.

According to the fifth aspect of the present disclosure, it is possible for acoustic system 100 to include correction filter 130 having filter properties in which actual conditions are accurately reflected, thereby effectively suppressing the passing of sound waves generated by sound generation device 110 as a result of vibrator 120 causing vibration member 220 to vibrate.

An acoustic system control method according to a sixth aspect of the present disclosure is an acoustic system control method of setting a filter property of correction filter 130 included in acoustic system 100 according to any one of the first to fifth aspects. The acoustic system control method includes: placing sound generation device 110 on one side of vibration member 220 to which vibrator 120 is attached; placing measurement device 350 on the other side of vibration member 220; obtaining a target measurement signal by causing measurement device 350 to measure a sound wave generated by sound generation device 110 based on acoustic signal 201; and setting the filter property of correction filter 130 based on a target sound-pressure transfer function between acoustic signal 201 and the target measurement signal.

According to the sixth aspect of the present disclosure, it is possible to reduce the amount of sound waves that were generated by sound generation device 110 and pass through vibration member 220.

An acoustic system control method according to a seventh aspect of the present disclosure is the acoustic system control method according to the sixth aspect, and includes: obtaining a corresponding measurement signal by causing measurement device 350 to measure, at a position at which the target measurement signal has been measured, a sound wave generated as a result of vibrator 120 causing vibration member 220 to vibrate based on acoustic signal 201; and setting the filter property of correction filter 130 based on a corresponding sound-pressure transfer function between acoustic signal 201 and the corresponding measurement signal.

According to the seventh aspect of the present disclosure, it is possible to control acoustic system 100 including correction filter 130 having filter properties in which actual conditions are accurately reflected.

An acoustic system control method according to an eighth aspect of the present disclosure is the acoustic system control method according to the sixth or seventh aspect, and the target measurement signal is obtained in a state in which vibrator 120 is short-circuited.

According to the eighth aspect of the present disclosure, it is possible to perform control using highly accurate filter property G.

An acoustic system control method according to a ninth aspect of the present disclosure is the acoustic system control method according to any one of the sixth to eighth aspects, and the filter property of correction filter 130 is set based on a process sound-pressure transfer function between a processed signal and acoustic signal 201, where the processed signal is obtained by performing statistical processing on corresponding sound-pressure transfer functions that are based on acoustic signal 201 and target measurement signals measured at different positions, each of the corresponding sound-pressure transfer functions is the corresponding sound-pressure transfer function, and each of the target measurement signals is the target measurement signal.

According to the ninth aspect of the present disclosure, it is possible to capture, in a plane, sound transmitting through vibration member 220, thereby effectively reducing transmitted sound in a desired area.

An acoustic system manufacturing method according to a tenth aspect of the present disclosure is an acoustic system manufacturing method for manufacturing acoustic system 100 according to any one of the first to fifth aspects, and includes: placing sound generation device 110 on one side of vibration member 220 to which vibrator 120 is attached; placing measurement device 350 on the other side of vibration member 220; obtaining a target measurement signal by causing measurement device 350 to measure at least one of (i) a sound wave generated by sound generation device 110 based on acoustic signal 201 or (ii) vibration of vibration member 220 caused by the sound wave generated by sound generation device 110; and setting the filter property of correction filter 130 based on a target sound-pressure transfer function between acoustic signal 201 and the target measurement signal.

According to the tenth aspect of the present disclosure, it is possible to manufacture acoustic system 100 capable of reducing the amount of sound waves that were generated by sound generation device 110 and pass through vibration member 220.

An acoustic system manufacturing method according to an eleventh aspect of the present disclosure is the acoustic system manufacturing method according to the tenth aspect, and includes: obtaining a corresponding measurement signal by causing measurement device 350 to measure, at a position at which the target measurement signal has been measured, a sound wave generated as a result of vibrator 120 causing vibration member 220 to vibrate based on acoustic signal 201; and setting the filter property of correction filter 130 based on a corresponding sound-pressure transfer function between acoustic signal 201 and the corresponding measurement signal.

According to the eleventh aspect of the present disclosure, it is possible to manufacture acoustic system 100 including correction filter 130 having filter properties in which actual conditions are accurately reflected.

An acoustic system manufacturing method according to a twelfth aspect of the present disclosure is the acoustic system manufacturing method according to the tenth or eleventh aspect, and the target measurement signal is obtained in a state in which vibrator 120 is short-circuited.

According to the twelfth aspect of the present disclosure, it is possible to generate highly accurate filter property G.

An acoustic system manufacturing method according to a thirteenth aspect of the present disclosure is the acoustic system manufacturing method according to any one of the tenth to twelfth aspects, and the filter property of correction filter 130 is set based on a process sound-pressure transfer function between a processed signal and acoustic signal 201, where the processed signal is obtained by performing statistical processing on corresponding sound-pressure transfer functions that are based on acoustic signal 201 and target measurement signals measured at different positions, each of the corresponding sound-pressure transfer functions is the corresponding sound-pressure transfer function, and each of the target measurement signals is the target measurement signal.

According to the thirteenth aspect of the present disclosure, it is possible to capture, in a plane, sound transmitting through vibration member 220, thereby effectively reducing transmitted sound in a desired area.

An acoustic system manufacturing method according to a fourteenth aspect of the present disclosure is the acoustic system manufacturing method according to any one of the eleventh to thirteenth aspects, and the filter property of correction filter 130 is set based on a process sound-pressure transfer function obtained by performing statistical processing on corresponding sound-pressure transfer functions that are based on acoustic signal 201 and target measurement signals measured at a plurality of locations whose total number is different from the total number of vibrators for measurement 320 attached to vibration member for measurement 329, where the total number of vibrators for measurement 329 is singular or plural, each of the corresponding sound-pressure transfer functions is the corresponding sound-pressure transfer function, each of the target measurement signals is the target measurement signal, and each of vibrators for measurement 329 is vibrator for measurement 329.

When the number of target measurement signals (the number of measurement positions) matches the number of vibrators 120 attached to vibration member 220, an unintended processing signal may be generated since filter property G to be derived is uniquely determined. According to the fourteenth aspect of the present disclosure, however, the number of target measurement signals (the number of measurement positions) does not match the number of vibrators 120 attached to vibration member 220 so that a robust control filter is capable of calculating without generating an unintended processing signal.

### Further Information about Technical Background to this Application

The disclosures of the following patent applications including specification, drawings, and claims are incorporated herein by reference in their entirety: Japanese Patent Application No. 2023-208605 filed on Dec. 11, 2023 and Japanese Patent Application No. 2024-194275 filed on Nov. 6, 2024.

### INDUSTRIAL APPLICABILITY

The present disclosure can be used in a mobile object or a building that includes a space in which the amount of sound waves that were generated in a first space, pass through a vibration member, and leak out to a second space is desired to be reduced.

1. An acoustic system comprising:
a sound generation device that generates a sound wave based on an acoustic signal;
a vibrator that applies vibration to a vibration member to which the vibrator is attached; and
a correction filter that (i) corrects the acoustic signal to reduce transmitted sound that has changed from the sound wave by transmitting through the vibration member, and (ii) outputs the acoustic signal corrected to the vibrator, wherein
the correction filter has a filter property derived based on a transfer characteristic of the transmitted sound.

2. The acoustic system according to claim 1, further comprising:
a delay filter that delays and outputs the acoustic signal to the sound generation device.

3. The acoustic system according to claim 1, further comprising:
a common filter that corrects both (i) the acoustic signal to be output to the vibrator and (ii) the acoustic signal to be output to the sound generation device.

4. The acoustic system according to claim 1, wherein
the correction filter has a filter property derived based on a target sound-pressure transfer function between a target measurement signal and the acoustic signal, the target measurement signal being obtained by measuring, on a side of the vibration member at which the sound generation device is not placed, at least one of (i) a sound wave generated by the sound generation device based on the acoustic signal or (ii) vibration excited by the vibration member due to the sound wave generated by the sound generation device.

5. The acoustic system according to claim 4, wherein
the correction filter has a filter property derived based on a corresponding sound-pressure transfer function between a corresponding measurement signal and acoustic signal 201, the corresponding measurement signal being obtained by measuring, at a position at which the target measurement signal has been measured, at least one of (i) a sound wave generated as a result of the vibrator causing the vibration member to vibrate based on acoustic signal 201 or (ii) the vibration.

6. An acoustic system control method of setting a filter property of a correction filter included in the acoustic system according to claim 1, the acoustic system control method comprising:
placing the sound generation device on one side of the vibration member to which the vibrator is attached;
placing a measurement device on an other side of the vibration member;
obtaining a target measurement signal by causing the measurement device to measure a sound wave generated by the sound generation device based on the acoustic signal; and
setting the filter property of the correction filter based on a target sound-pressure transfer function between the acoustic signal and the target measurement signal.

7. The acoustic system control method according to claim 6, further comprising:
obtaining a corresponding measurement signal by causing the measurement device to measure, at a position at which the target measurement signal has been measured, a sound wave generated as a result of the vibrator causing the vibration member to vibrate based on the acoustic signal; and
setting the filter property of the correction filter based on a corresponding sound-pressure transfer function between the acoustic signal and the corresponding measurement signal.

8. The acoustic system control method according to claim 6, wherein
the target measurement signal is obtained in a state in which the vibrator is short-circuited.

9. The acoustic system control method according to claim 7, wherein
the filter property of the correction filter is set based on a process sound-pressure transfer function between a processed signal and the acoustic signal, the processed signal being obtained by performing statistical processing on corresponding sound-pressure transfer functions that are based on the acoustic signal and target measurement signals measured at different positions, each of the corresponding sound-pressure transfer functions being the corresponding sound-pressure transfer function, each of the target measurement signals being the target measurement signal.

10. An acoustic system manufacturing method for manufacturing the acoustic system according to claim 1, the acoustic system manufacturing method comprising:
placing the sound generation device on one side of the vibration member to which the vibrator is attached;
placing a measurement device on an other side of the vibration member;
obtaining a target measurement signal by causing the measurement device to measure at least one of (i) a sound wave generated by the sound generation device based on the acoustic signal or (ii) vibration of the vibration member caused by the sound wave generated by the sound generation device; and
setting the filter property of the correction filter based on a target sound-pressure transfer function between the acoustic signal and the target measurement signal.

11. The acoustic system manufacturing method according to claim 10, further comprising:
obtaining a corresponding measurement signal by causing the measurement device to measure, at a position at which the target measurement signal has been measured, a sound wave generated as a result of the vibrator causing the vibration member to vibrate based on the acoustic signal; and
setting the filter property of the correction filter based on a corresponding sound-pressure transfer function between the acoustic signal and the corresponding measurement signal.

12. The acoustic system manufacturing method according to claim 10, wherein
the target measurement signal is obtained in a state in which the vibrator is short-circuited.

13. The acoustic system manufacturing method according to claim 11, wherein
the filter property of the correction filter is set based on a process sound-pressure transfer function between a processed signal and the acoustic signal, the processed signal being obtained by performing statistical processing on corresponding sound-pressure transfer functions that are based on the acoustic signal and target measurement signals measured at different positions, each of the corresponding sound-pressure transfer functions being the corresponding sound-pressure transfer function, each of the target measurement signals being the target measurement signal.

14. The acoustic system manufacturing method according to claim 11, wherein
the filter property of the correction filter is set based on a process sound-pressure transfer function obtained by performing statistical processing on corresponding sound-pressure transfer functions that are based on the acoustic signal and target measurement signals measured at a plurality of locations whose total number is different from a total number of vibrators attached to the vibration member, the total number of the vibrators being singular or plural, each of the corresponding sound-pressure transfer functions being the corresponding sound-pressure transfer function, each of the target measurement signals being the target measurement signal, each of the vibrators being the vibrator.
